(19) United States
(12) Patent Application Publication
(10) Pub. No.: US 2025/0322305 A1
(43) Pub. Date: Oct. 16, 2025

(54) HIGH-SPEEED RETRIEVAL METHOD FOR DIGITAL TWIN MODEL USING BINARY TAGGING NUMBERS

(71) Applicant: ELECTRONICS AND TELECOMMUNICATIONS RESEARCH INSTITUTE, Daejeon (KR)

(72) Inventor: Ki-Sook CHUNG, Daejeon (KR)

(21) Appl. No.: 18/983,730

(22) Filed: Dec. 17, 2024

(30) Foreign Application Priority Data
Apr. 11, 2024 (KR) 10-2024-0048645

(51) Int. Cl. G06N 20/00

(52) U.S. Cl. CPC G06N 20/00

(57) ABSTRACT

Disclosed is a method of retrieving a digital twin model of a digital twin device. The method includes generating a retrieval binary tag that matches a retrieval condition, performing a logical operation between the retrieval binary tag and the binary tag representing features of the digital twin model, and adding model IDs of each of digital twin models corresponding to the binary tag in a retrieval list when it is determined that the retrieval binary tag is the same as the binary tag, based on a result of the logical operation, and each of binary tags includes a plurality of bits to which a plurality of tags are respectively assigned, and each of the plurality of bits has a first logical value or a second logical value based on whether the digital twin models have features assigned to the corresponding tags.

### CROSS-REFERENCE TO RELATED APPLICATION(S)

This application claims priority under 35 U.S.C. § 119 to Korean Patent Application No. 10-2024-0048645 filed on Apr. 11, 2024, in the Korean Intellectual Property Office, the disclosures of which are incorporated by reference herein in their entireties.

### BACKGROUND

### 1. Field of the Invention

Embodiments of the present disclosure described herein relate to a digital twin system, and more particularly, relate to a digital twin model device and an operating method thereof.

### 2. Description of Related Art

Digital twins may be generated based on forms of a real world, a virtual world, and an interconnection between the two worlds. The digital twins are attracting attention as a technology for solving problems in various industrial fields including manufacturing and social problems, as big data analytics, modelings, simulations, and network elements advance. The digital twins may generate a virtual world by replicating the real world such as objects, spaces, and processes, may analyze various data collected in the real world in the generated virtual world, and may suggest optimal solutions to problems.

Multiple digital twin models may be generated for multiple real worlds. Since multiple digital twin models have a large amount of data, quickly retrieving digital twin models that match conditions such as simulations is essential for improving the performance of digital twins.

### SUMMARY

Embodiments of the present disclosure provide a device and a method by which digital twin models matching conditions may be quickly retrieved.

According to an embodiment of the present disclosure, a method of retrieving a digital twin model of a digital twin device that generates and manages digital twin models and binary tags representing features of each of the digital twin models, includes generating a retrieval binary tag that matches a retrieval condition, performing a logical operation between the retrieval binary tag and the binary tag representing the features of the digital twin model, and adding model IDs of each of the digital twin models corresponding to the binary tag in a retrieval list when it is determined that the retrieval binary tag is the same as the binary tag, based on a result of the logical operation, and each of the binary tags includes a plurality of bits to which a plurality of tags are respectively assigned, and each of the plurality of bits has a first logical value or a second logical value based on whether the digital twin models have features assigned to the corresponding tags.

According to an embodiment, when the binary tag is not a last binary tag, the method may further include loading a subsequent binary tag.

According to an embodiment, the logical operation may be an AND operation between each bit of the retrieval binary tag and each bit of the corresponding binary tag.

According to an embodiment, the logical operation may be an XNOR (exclusive NOR) operation between each bit of the retrieval binary tag and each bit of the corresponding binary tag.

According to an embodiment, the digital twin device may include a processing block that generates the digital twin models, and a database block that stores the digital twin models and the binary tags corresponding to each of the digital twin models, and the binary tags may be generated by the processing block.

According to an embodiment, a mapping relationship between the digital twin models and the binary tags may be stored in the database block.

According to an embodiment, a mapping relationship between the digital twin models and the binary tags may be stored in a buffer block included in the digital twin device, and the buffer block may store data required for an operation of the digital twin device.

According to an embodiment, the mapping relationship may be stored in a mapping table, and the mapping table may include model IDs of each of the digital twin models and the binary tags.

According to an embodiment of the present disclosure, a digital twin device that generates and manages digital twin models includes a processing block that generates the digital twin models, and a database block that stores the digital twin models and the binary tags corresponding to each of the digital twin models, and each of the binary tags includes a plurality of bits to which a plurality of tags are respectively assigned, and each of the plurality of bits has a first logical value or a second logical value based on whether the digital twin models have features assigned to the corresponding tags.

According to an embodiment, the database block may further include a mapping module, and the mapping module may include a mapping relationship between the binary tags and the digital twin models.

According to an embodiment, the processing block may include a digital twin generation module that generates the digital twin models, a binary tag number generation module that generates the binary tags corresponding to the features of the digital twin models, and a retrieval module that retrieves the binary tags.

According to an embodiment, the database block may include a digital twin model data module that stores the digital twin models, and a binary tag number module that stores the binary tags.

According to an embodiment, the digital twin device may further include a buffer block that stores data required for an operation of the processing block.

According to an embodiment, the mapping relationship may be stored in the buffer block.

According to an embodiment, the database block may further include a mapping data module that stores the mapping relationship.

According to an embodiment, the mapping relationship may be stored in the database block in a form of a mapping table between model IDs of each of the digital twin models and the binary tags.

According to an embodiment of the present disclosure, a method of generating a digital twin model and a binary tag of a digital twin device that generates the digital twin models, includes selecting a plurality of tags corresponding to each of the plurality of bits in the binary tag including a plurality of bits, and assigning a feature to each of the plurality of tags, generating the digital twin model and changing values of the plurality of bits of the binary tag so as to match the feature of the digital twin model, and storing the digital twin model and the binary tag, and each of the plurality of bits has a first logical value or a second logical value based on whether the digital twin models have features assigned to the corresponding tags.

### BRIEF DESCRIPTION OF THE DRAWINGS

The above and other objects and features of the present disclosure will become apparent by describing in detail embodiments thereof with reference to the accompanying drawings.

FIG. 1 is a block diagram illustrating a digital twin device, according to an embodiment of the present disclosure.

FIG. 2 is a block diagram illustrating a processing block of FIG. 1, according to an embodiment of the present disclosure.

FIG. 3 is a block diagram illustrating a database block of FIG. 1 in detail, according to an embodiment of the present disclosure.

FIG. 4 is a diagram illustrating a relationship between a binary tag and a digital twin model, according to an embodiment of the present disclosure.

FIG. 5 is a diagram illustrating a mapping table between binary tags and digital twin models, according to an embodiment of the present disclosure.

FIG. 6 is a flowchart illustrating a method for generating a digital twin model and a binary tag, according to an embodiment of the present disclosure.

FIG. 7 is a flowchart illustrating a method for retrieving a digital twin model based on a binary tag, according to an embodiment of the present disclosure.

### DETAILED DESCRIPTION

Hereinafter, embodiments of the present disclosure will be described in detail and clearly to such an extent that an ordinary one in the art easily implements the present disclosure.

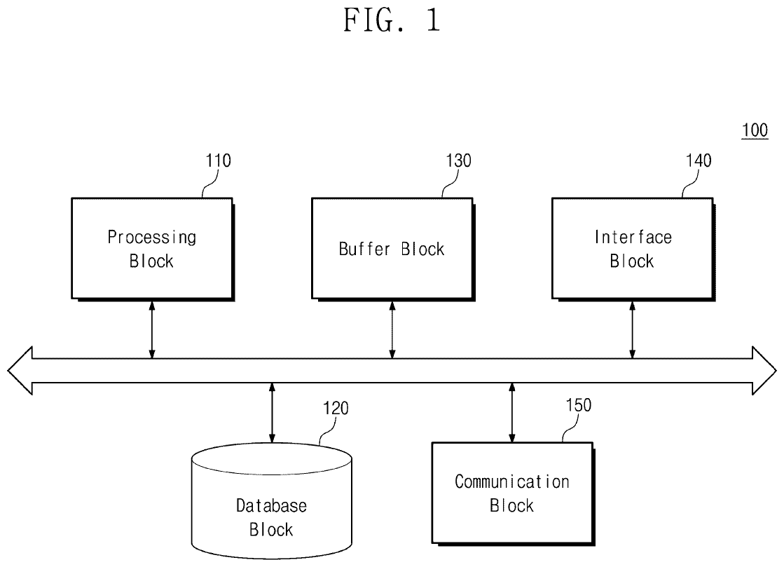

FIG. 1 is a block diagram illustrating a digital twin device, according to an embodiment of the present disclosure. Referring to FIG. 1, a digital twin device 100 may include a processing block 110, a database block 120, a buffer block 130, an interface block 140, and a communication block 150.

The digital twin device 100 may be a device that generates and manages digital twin models. The digital twin model may be a model that generates a virtual world corresponding to a real world and stores interconnections between them. In an embodiment, the digital twin device 100 may generate a plurality of digital twin models. For example, the digital twin device 100 may generate digital twin models for each of a plurality of conditions with respect to one real world. For another example, the digital twin device 100 may generate digital twin models corresponding to a plurality of conditions for each of a plurality of real worlds. In an embodiment, the digital twin device 100 may generate and manage binary tags that indicate features of the generated digital twin models.

The digital twin device 100 may be implemented based on various devices. In an embodiment, the digital twin device 100 may be included in various electronic devices. For example, the digital twin device 100 may be included in various electronic devices such as a personal computer (PC), a tablet PC, a laptop PC, a smartphone, and a personal digital assistant (PDA).

The processing block 110 may generate and manage a digital twin model. In an embodiment, the processing block 110 may generate a digital twin model based on the real world received from the interface block 140. For example, the processing block 110 may generate a digital twin model based on data such as an image or voice received from the interface block 140.

In an embodiment, the processing block 110 may include at least one processor. For example, the processing block 110 may include at least one of various processors (e.g., a central processing unit (CPU), a graphics processing unit (GPU), a neural processing unit (NPU), or an application processor (AP)). In an embodiment, the processing block 110 may operate in response to control from an external device or a user. For example, the processing block 110 may operate in response to a control signal from an external device received from the communication block 150, or may operate in response to a user control signal received from the interface block 140.

The processing block 110 may generate and manage binary tags associated with features of each of the digital twin models. In an embodiment, the binary tag may be a digital form of data having an arbitrary length and may express features of the digital twin model. In an embodiment, features with respect to each tag included in the binary tags may be assigned. For example, the binary tag may have a length of 32 bits, features may be assigned to each bit, and features of the digital twin model may be expressed through a value of each bit. In an embodiment, each value of digits of the binary tag may have a first logic value or a second logical value depending on whether the digital twin model has a feature. For example, when the digital twin model has a specific feature, the binary tag may have a logic 1 value with respect to the bit digit corresponding to the specific feature.

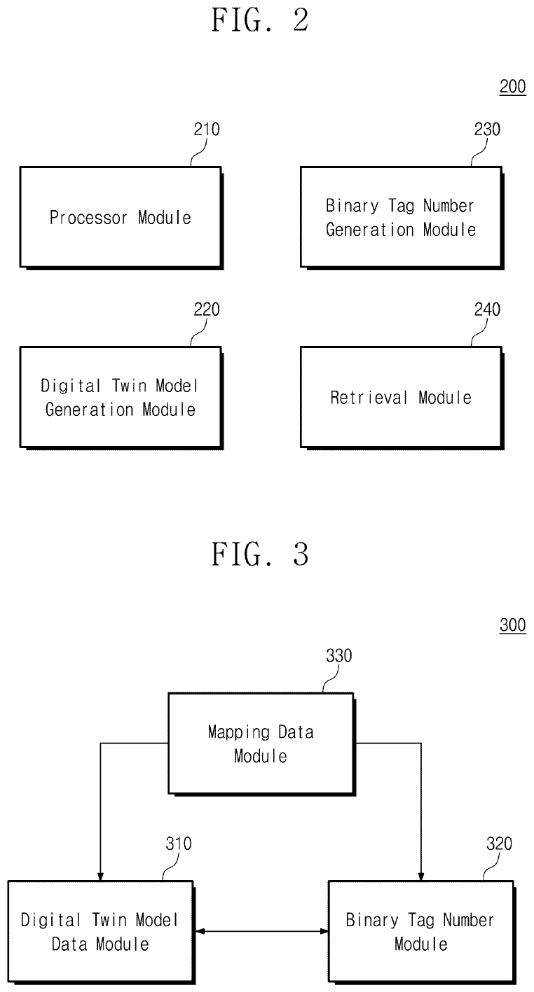

The processing block 110 may retrieve digital twin models stored in the digital twin device 100. In an embodiment, the processing block 110 may retrieve digital twin models stored in the database block 120. In another embodiment, the processing block 110 may retrieve the digital twin models that match a condition, using a binary tag. For example, the processing block 110 may retrieve the digital twin models that match a condition among digital twin models stored in the database block 120 using a binary tag. The processing block 110 will be described in more detail with reference to FIG. 2.

The database block 120 may store digital twin models and their binary tags. In an embodiment, the database block 120 may include a plurality of memory devices. For example, the database block 120 may include a nonvolatile memory device (e.g., a NAND flash memory device, etc.) and/or a volatile memory device (e.g., a static random access memory (SRAM), or a dynamic RAM (DRAM), etc.).

The database block 120 may store data based on any data structure. For example, the database block 120 may store digital twin models, binary tags, and the relationships between them, based on a relational data structure. The database block 120 will be described in more detail with reference to FIG. 3.

The buffer block 130 may store data required for an operation of the digital twin device 100. In an embodiment, the buffer block 130 may store data required for an operation of the processing block 110, or data generated by the operation. For example, the buffer block 130 may receive data required for the operation of the processing block 110 from the database block 120. In another example, the buffer block 130 may store data generated by the operation of the processing block 110 and to be stored in the database block 120.

In an embodiment, the buffer block 130 may include various memory devices. For example, the buffer block 130 may include a volatile memory device. For a more detailed example, the buffer block 130 may include an SRAM device or a DRAM device. In another embodiment, the buffer block 130 may perform various operations such as a cache memory.

The interface block 140 may provide a connection between the digital twin device 100 and external devices. In an embodiment, the interface block 140 may receive various data required for creating a digital twin model. For example, the interface block 140 may receive image data (e.g., in various bands such as infrared, visible light, etc.) from a camera, may receive various conditions about the real world through a user input (e.g., keyboard, etc.), or may receive voice data through a microphone, etc.

The interface block 140 may transfer the received inputs to the processing block 110 or the buffer block 130. In an embodiment, the interface block 140 may receive a user control signal. For example, the interface block 140 may receive a control signal input by a user from an input device such as a mouse or a keyboard, and may transfer the control signal input to the processing block 110 or the buffer block 130.

The communication block 150 may perform communication with an external device. In an embodiment, the communication block 150 may communicate with an external device wiredly, or may communicate with an external device wirelessly. In an embodiment, the communication block 150 may receive a control signal or data for the digital twin device 100 wiredly or wirelessly, and may transfer the received control signal or the data to the processing block 110. In another embodiment, the communication block 150 may transfer the operation result of the digital twin device 100 to an external device. For example, the communication block 150 may cause the retrieval result for digital twin models that match a condition to be transmitted to an external device.

FIG. 2 is a block diagram illustrating a processing block of FIG. 1 in detail, according to an embodiment of the present disclosure. A processing block 200 may correspond to the processing block 110 of FIG. 1. Referring to FIG. 2, the processing block 200 may include a processor module 210, a digital twin model generation module 220, a binary tag number generation module 230, and a retrieval module 240. The division of each module of the processing block 200 described through FIG. 2 is an example and may be a division according to functions, and the scope of the present disclosure should not be limited thereto.

The processor module 210 may control the digital twin device 100 of FIG. 1. In an embodiment, the processor module 210 may control each component of the digital twin device 100 of FIG. 1. For example, referring to FIG. 1 together, the processor module 210 may allow data generated by the operation of the processing block 110 to be written to the database block 120. For another example, the processor module 210 may write data to be written in the database block 120 in the buffer block 130 and then may allow the data to be transferred to the database block 120.

In an embodiment, the processor module 210 may control operations of other modules. For example, the processor module 210 may receive a control signal and data to allow the digital twin model generation module 220 to generate digital twin models. For another example, the processor module 210 may transfer features to be assigned to binary tags to the binary tag number generation module 230. The features to be assigned to binary tags may be generated by the processor module 210 or may be received from the outside through the interface block 140 or the communication block 150.

The digital twin model generation module 220 may generate a virtual world with respect to the real world. In an embodiment, the digital twin model generation module 220 may generate a digital twin model corresponding to the real world (or a virtual world corresponding to the real world) based on data received from the outside. For example, the digital twin model generation module 220 may generate a digital twin model corresponding to the real world, based on data received from an external device or received through the interface block 140 by a camera, etc.

In an embodiment, the digital twin model generation module 220 may generate digital twin models corresponding to each of a plurality of conditions of one real world. In an embodiment, the digital twin model generation module 220 may transfer the generated digital twin models to the database block 120. For example, the digital twin model generation module 220 may generate digital twin models corresponding to the plurality of conditions of each of a plurality of real worlds and may store them in the database block 120. In another embodiment, the digital twin model generation module 220 may transfer the generated digital twin models to the binary tag number generation module 230 such that binary tags may be assigned to each of the digital twin models.

The binary tag number generation module 230 may generate binary tags for classifying the digital twin models. In an embodiment, the binary tag number generation module 230 may assign features to each address of the binary tags, and the features may be related to characteristics of the digital twin models. For example, the binary tag number generation module 230 may assign a first feature to a zeroth address of the binary tag and may assign a second feature to a first address of the binary tag. The values indicated by each address of the binary tag may be a first logical value (e.g., logic 1) or a second logical value (e.g., logic 0).

The binary tag number generation module 230 may generate binary numbers corresponding to each of the digital twin models based on the assigned features. For example, the binary tag number generation module 230 may cause the value corresponding to the zeroth address of the first binary tag of the first digital model to be logic 1 when the first digital model has a first feature corresponding to the zeroth address.

The binary tag number generation module 230 may map binary tags corresponding to the digital twin models. In an embodiment, the binary tag number generation module 230 may generate a mapping between the digital twin models and the binary tags based on an arbitrary data structure. In another embodiment, the binary tag number generation module 230 may generate a mapping between each of the IDs of the digital twin models and the corresponding binary tags based on an arbitrary data structure. For example, the binary tag number generation module 230 may store the relationship between each of the IDs of the digital twin models and the binary tags in the form of a mapping table. The binary tag number generation module 230 may store the generated mapping in the buffer block 130 or the database block 120.

The retrieval module 240 may retrieve the digital twin models based on the binary tags. In an embodiment, the retrieval module 240 may retrieve the digital twin models based on a logical operation between the retrieval binary tag and the binary tags. For example, when the digital twin model whose value of the zeroth address corresponding to the first feature of the binary tag is logic 1 is retrieved, the retrieval module 240 may perform a retrieval operation based on the retrieval binary tag whose value of the zeroth address is logic 1.

For example, the retrieval module 240 may retrieve the digital twin models based on an AND operation of corresponding values between the binary tag and the retrieval binary tag. For another example, the retrieval module 240 may retrieve the digital twin models based on an XNOR (exclusive NOR) operation of corresponding values between the binary tag and the retrieval binary tag. In an embodiment, the retrieval module 240 may generate retrieval binary tags with respect to two or more features, and may retrieve the digital twin models based on the XNOR operation. In an embodiment, the retrieval module 240 may transfer model IDs of each of the digital twin models that are determined to match the retrieval conditions to the processor module 210.

The modules illustrated and described in FIG. 2 are functionally distinct, and the scope of the present disclosure is not limited thereto. It should be understood that functions performed by a specific module may be performed by other modules. For example, it should be understood that the mapping between the binary tag and the digital twin model performed by the binary tag number generation module 230 may be performed by the processor module 210. In an embodiment, the modules of FIG. 2 may be implemented in the form of software executable by at least one hardware. For example, the processing block 200 may include a processor (e.g., a CPU or an AP, etc.) that may execute software, configured to perform the functions of each of the digital twin model generation module 220, the binary tag number generation module 230, or the retrieval module 240. For another example, the processing block 200 may include a CPU configured to perform the operations of the modules 210, 220, 230, and 240.

FIG. 3 is a block diagram illustrating a database block of FIG. 1 in detail, according to an embodiment of the present disclosure. A database block 300 may correspond to the database block 120 of FIG. 1. Referring to FIG. 3, the database block 300 may include a digital twin model data module 310, a binary tag number module 320, and a mapping data module 330.

The digital twin model data module 310 may store data of digital twin models. In an embodiment, the digital twin model data module 310 may store the digital twin models generated by the processing block 110 of FIG. 1. For example, the digital twin model data module 310 may store data of digital twin models that match a plurality of conditions of each of a plurality of real worlds.

The data of the digital twin models may include information on a space of a target real world, or information on an object included in a space. In an embodiment, the digital twin model data module 310 may store identifiers for identifying digital twin models together. For example, the digital twin model data module 310 may store IDs (identifiers) of each of the digital twin models. In an embodiment, the digital twin model data module 310 may store the digital twin models and the corresponding identifiers based on any data structure.

The binary tag number module 320 may store binary tags regarding features of the digital twin models. In an embodiment, the binary tag number module 320 may store binary tags generated from the processing block 110 of FIG. 1. For example, the binary tag number module 320 may store binary tags generated from the binary tag number generation module 230 of FIG. 2.

The mapping data module 330 may include mapping information (or mapping relationship) between the digital twin models and the binary tags. In an embodiment, the mapping data module 330 may include mapping information between the digital twin models and the binary tags generated from the processing block 110. In an embodiment, the mapping information included in the mapping data module 330 may be generated or implemented based on any data structure. For example, the mapping data module 330 may include a mapping table including relationships between digital twin models and respective binary tags.

The modules illustrated and described through FIG. 3 may be divisions of memory areas within the database block 300, and should be understood as divisions according to functions, operations, or types of data to be stored. In addition, it should be understood that an embodiment in which each of the functions of the modules 310, 320, and 330 is performed in whole or in part by other modules is also within the scope of the present disclosure. For example, it should be understood that a form in which information stored in the modules 310, 320, and 330 is stored or included in the database block 300 in the form of a single table according to each of the digital twin models is also within the scope of the present disclosure. In this case, the database block 300 may not include the mapping data module 330. In an embodiment, the modules 310, 320, and 330 may be physically or logically separated within the same memory device (e.g., a nonvolatile memory device). In another embodiment, at least some of the modules 310, 320, and 330 may be contained within different memory devices.

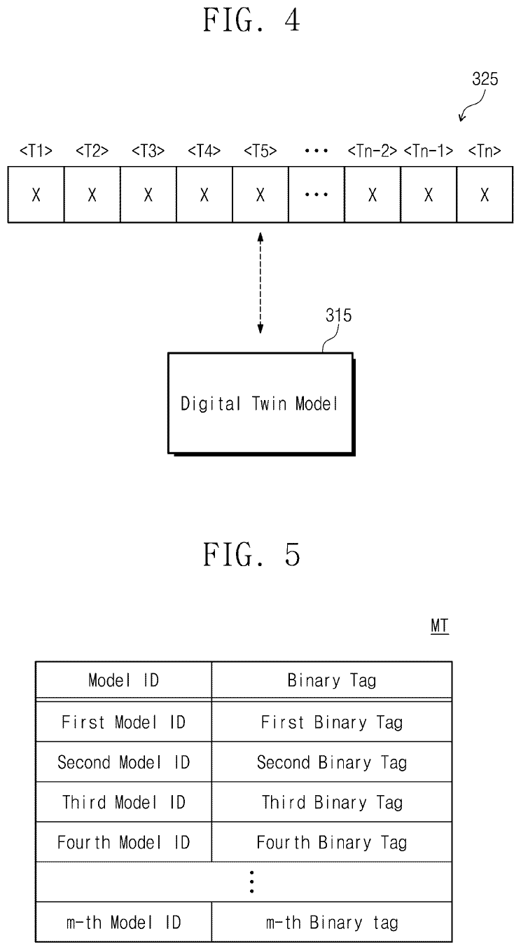

FIG. 4 is a diagram illustrating a relationship between a digital twin model and a binary tag, according to an embodiment of the present disclosure. Referring to FIG. 4, a digital twin model 315 and a binary tag 325 are illustrated. The digital twin model 315 may be a model stored in the digital twin model data module 310 of FIG. 3. The binary tag 325 may be a tag corresponding to the digital twin model 315 and stored in the binary tag number module 320. Through FIG. 4, the relationship between the digital twin model and the binary tag is described in detail.

The digital twin model 315 may be a digital twin corresponding to (or matching) the real world. The digital twin model 315 may be generated according to the operations and methods described through FIGS. 1 to 3. The digital twin model 315 may have a plurality of features depending on the characteristics of the model.

The binary tag 325 may include a plurality of tags. For example, referring to FIG. 4, the binary tag 325 may include a first tag T1, a second tag T2, and a third tag T3 to an n-th tag Tn (where “n” is any natural number). In an embodiment, each of the tags T1 to Tn may correspond to an address (or a bit digit) of the binary tag. For example, the first tag T1 may correspond to an address of the most significant bit, and the n-th tag Tn may correspond to an address of the least significant bit.

In an embodiment, each of the tags T1 to Tn may be assigned features of a digital twin model. For example, features related to the temperature of a space that is the target of the digital twin model may be assigned to the first tag T1. In an embodiment, the digital twin model may or may not have each of the features assigned to the tags T1 to Tn. For example, the features assigned to the first tag T1 may be whether the temperature of the digital twin model space is 25 degrees or higher, and the digital twin model 315 may or may not have the features of the first tag T1.

In an embodiment, the bit value of the binary tag corresponding to the tags T1 to In may have a first logical value or a second logical value. For example, when the digital twin model 315 corresponding to the binary tag 325 has a feature corresponding to the first tag T1, the value of the bit corresponding to the first tag T1 may be logic 1. Likewise, when the digital twin model 315 has a feature corresponding to the second tag T2, the value of the bit corresponding to the second tag T2 may be logic 1. For another example, when the digital twin model 315 does not have a feature corresponding to the n-th tag Tn, the value of the bit corresponding to the n-th tag In may be logic 0. An “X” of the binary tag 325 of FIG. 4 may have a value of logic 1 or logic 0.

The features corresponding to the tags T1 to Tn of the binary tag 325 may be assigned in advance. For example, referring to FIG. 1 together, the features of each of the tags T1 to Tn of the binary tag 325 may be set and assigned by the processing block 110 depending on a control signal or data received through the communication block 150 or the interface block 140. The binary tag 325 may be stored in the binary tag number module 320 of FIG. 3 in the form of an n-digit bit number.

As described through FIG. 4, by expressing the features of the digital twin model 315 as binary tags 325, the digital twin device 100 of FIG. 1 may provide a quick retrieval. For example, when a digital twin model having features of the second tag T2 and the third tag T3 is retrieved, the digital twin device 100 may retrieve a digital twin model in which all bit values corresponding to the second tag T2 and the third tag T3 are logic 1, thereby finding the desired digital twin model. The retrieval of the digital twin model of the digital twin device 100 may be performed based on a logical operation (e.g., an AND operation, or an XNOR operation, etc.) between the binary tag and the retrieval binary tag, as described through FIG. 2.

In the binary tag 325 of FIG. 4, an addition of features for classifying digital twin models may be easily performed. For example, by adding a tag to a bit above the most significant bit or a bit below the least significant bit in the binary tag 325, the features included in the digital twin model may be additionally assigned and expressed in the binary tag 325. Since the binary tag 325 expresses the features of the digital twin models in digital form data, the presence or absence of a feature may be determined only with the bits of each tag, so that the retrieval for a digital twin model having a specific feature may be performed at high speed.

FIG. 5 is a diagram illustrating a mapping table between digital twin models and binary tags, according to an embodiment of the present disclosure. Referring to FIG. 5, a mapping table MT between a model ID and a binary tag is illustrated. Through FIG. 5, a relationship between digital twin models and binary tags described through FIGS. 1 to 4 is described.

The mapping table MT may be generated by the processing block 110 of FIG. 1 and may be stored in the mapping data module 330 of FIG. 3. The model ID may indicate an identifier of a digital twin model. For example, a first model ID may be an identifier used to identify a first digital twin model, and a second model ID may be an identifier used to identify a second digital twin model.

The binary tags may have a mapping relationship with the model ID. For example, a first binary tag may be mapped to the first model ID, and an m-th binary tag may correspond to an m-th model ID. Here, “m” may be the number of digital twin models generated by the digital twin device 100 of FIG. 1. In an embodiment, any binary tags may be identical to each other. For example, binary tags of two digital twin models that include the same features expressed as tags in the binary tags may be identical to each other.

The mapping table MT described through FIG. 5 is an example, and the scope of the present disclosure is not limited thereto. In an embodiment, the mapping relationship between model IDs and binary tags may be generated or stored based on any data structure capable of expressing the mapping relationship.

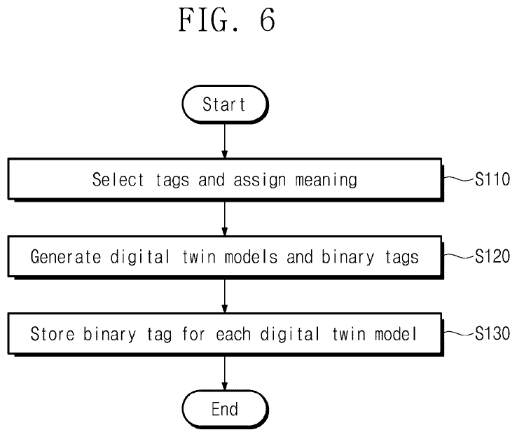

FIG. 6 is a flowchart illustrating an operation method of the digital twin device of FIG. 1 generating a digital twin model and corresponding binary tags, according to an embodiment of the present disclosure. Through FIGS. 1 to 6, an operation method of the digital twin device 100 generating digital twin models and corresponding binary tags, according to an embodiment of the present disclosure is described.

In operation S110, the digital twin device 100 may select tags and may assign meaning with respect to the tags. In an embodiment, the digital twin device 100 may determine the number of tags and a length of the binary tag, and may assign features to each tag of the binary tag. For example, the digital twin device 100 may generate a binary tag with a length of 16 bits, the number of tags may be “16”, and 16 features may be assigned to the binary tag.

The digital twin device 100 may assign features to each tag of the binary tags. In an embodiment, the features assigned by the digital twin device 100 with respect to the binary tags may be features that a digital twin model may be determined to have or not have. For example, a bit value corresponding to a specific tag of a binary tag may have logic 1 when the digital twin model has a feature corresponding to the specific tag. For another example, a bit value corresponding to a specific tag of a binary tag may have logic 0 when the digital twin model does not have a feature corresponding to the specific tag.

In operation S120, the digital twin device 100 may generate the digital twin models. In an embodiment, the digital twin device 100 may generate the digital twin models through the processing block 110 and may store the digital twin models in the database block 120. For example, the digital twin device 100 may generate the digital twin models corresponding to a plurality of conditions of each of multiple real worlds, based on a control signal or data received through the interface block 140 or the communication block 150, using the processing block 110. The digital twin device 100 may cause the generated digital twin models to be stored in the database block 120.

The digital twin device 100 may generate the binary tags corresponding to each of the generated digital twin models. In an embodiment, the digital twin device 100 may determine the values of each bit of the binary tags depending on the features of the digital twin models. For example, the digital twin device 100 may generate binary tag numbers having bit values depending on the features of the digital twin models.

In operation S130, the digital twin device 100 may store the binary tag for each digital twin model. In an embodiment, the digital twin device 100 may store the binary tags and the generated digital twin models. In an embodiment, the digital twin device 100 may generate a mapping relationship between the digital twin models and the binary tags. In an embodiment, the digital twin device 100 may store the digital twin models and the binary tags in the database block 120. For example, the digital twin device 100 may store the digital twin models and the binary tags in the database block 120 in a form described through FIGS. 4 and 5.

In FIG. 6, operations S110, S120, and S130 are illustrated and described as being performed sequentially, but the scope of the present disclosure is not limited thereto. It should be understood that an embodiment in which operation S110 is performed during the execution of operation S120, or an embodiment in which at least a part of operations S110 and S120 are performed simultaneously, is also within the scope of the present disclosure. For another example, It should be understood that an embodiment in which operation S130 is performed on the digital twin models and the binary tags already generated during the execution of operation S110 or operation S120, is also within the scope of the present disclosure.

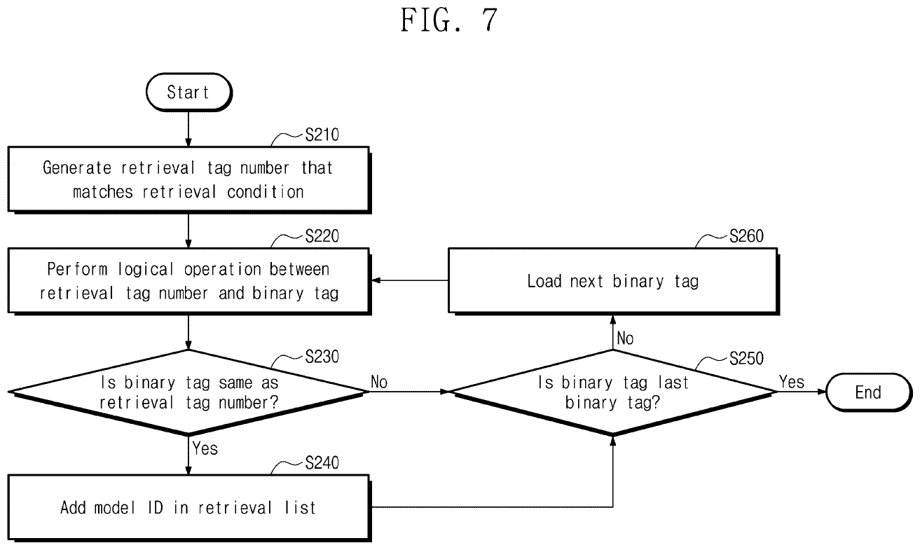

FIG. 7 is a flowchart illustrating a method of an operation in which the digital twin device of FIG. 1 retrieves digital twin models based on binary tags, according to an embodiment of the present disclosure. Through FIGS. 1 to 7, an embodiment of retrieving digital twin models based on features according to an embodiment of the present disclosure is described.

In operation S210, the digital twin device 100 may generate a retrieval binary tag that matches the retrieval condition. In an embodiment, the digital twin device 100 may generate a retrieval binary tag according to the retrieval condition through the retrieval module 240 in the processing block 110 of FIG. 1. For example, when the digital twin device 100 retrieves digital twin models having a feature corresponding to the first tag, the digital twin device 100 may generate a retrieval binary tag whose bit value corresponding to the first tag is logic 1. For another example, when the digital twin device 100 retrieves digital twin models that do not have a feature corresponding to the second tag, the digital twin device 100 may generate a retrieval binary tag whose bit value corresponding to the second tag is logic 0.

In operation S220, the digital twin device 100 may perform a logical operation between the retrieval binary tag and the binary tag of the digital twin model. In an embodiment, the digital twin device 100 may perform an AND operation or an XNOR operation between the retrieval binary tag and the binary tag to determine whether the binary tag is the same as the retrieval binary tag. For example, when the digital twin device 100 retrieves a digital twin model having specific features, the digital twin device 100 may perform an AND operation between the corresponding bits between the retrieval binary tag and the binary tag. For another example, when the digital twin device 100 retrieves a digital twin model having specific features or not having specific features, the digital twin device 100 may perform an XNOR operation between the corresponding bits between the retrieval binary tag and the binary tag. In an embodiment, the digital twin device 100 may perform the above-described operations through the retrieval module 240.

In operation S230, the digital twin device 100 may determine whether the retrieval binary tag is the same as the binary tag. In an embodiment, the digital twin device 100 may determine whether the retrieval binary tag is the same as the binary tag based on the operation result of operation S220. For example, when the digital twin device 100 determines whether the retrieval binary tag is the same as the binary tag based on an AND operation, when the operation result is the same as the retrieval binary tag, it may be determined that the digital twin model has the features.

For another example, when the digital twin device 100 determines whether the retrieval binary tag is the same as the binary tag based on an XNOR operation, when all bits of the operation result have logic 1, it may be determined that the digital twin model has or does not have the features to be retrieved. Alternatively, when the digital twin device 100 determines whether the retrieval binary tag is the same as the binary tag based on an XNOR operation, when all bit values of the positions of the tags corresponding to the features to be retrieved in the operation result are logic 1, it may be determined that the digital twin model has or does not have the features to be retrieved. When the digital twin device 100 determines that the retrieval binary tag is the same as the binary tag (or the digital twin device 100 determines that the digital twin model has or does not have the features), operation may proceed to operation S240. When the digital twin device 100 determines that the retrieval binary tag is different from the binary tag, operation may proceed to operation S250.

In operation S240, the digital twin device 100 may add a model ID corresponding to the binary tag in the retrieval list. In an embodiment, the digital twin device 100 may add model IDs of at least one digital twin model corresponding to the binary tag of operations S220 and S230 in the retrieval list by referring to the mapping table MT of FIG. 5. In an embodiment, the retrieval list may be included or stored in the buffer block 130 of FIG. 1. In another embodiment, the retrieval list may be included or stored in the database block 120 of FIG. 1.

After operation S240 is finished, the digital twin device 100 may move to operation S250. In operation S250, the digital twin device 100 may determine operation to proceed based on whether the retrieval binary tag is the last binary tag. When the binary tag is the last binary tag, the digital twin device 100 may end the retrieval operation. When the binary tag is not the last binary tag, the digital twin device 100 may move to operation S260.

In operation S260, the digital twin device 100 may load a binary tag to be retrieved next. For example, the digital twin device 100 may load the binary tag to be retrieved next into the buffer block 130 of FIG. 1. The digital twin device 100 may load the binary tag to be retrieved next and then move to operation S220 to perform operations S220 to S250. The digital twin device 100 may perform the retrieval operation for all the binary tags stored in the database block 120 based on the operations of operations S220 to S260.

The embodiments illustrated and described through FIG. 7 are an example and the scope of the present disclosure is not limited thereto. It should be understood that at least some of the operations of FIG. 7 may be performed in an overlapping manner or the order of the operations may be changed. For example, while operations S220 to S240 are being performed, operation S250 for determining whether the binary tag to be retrieved is the last binary tag may be performed simultaneously.

According to an embodiment of the present disclosure, a device and method are provided by which digital twin models matching conditions may be quickly retrieved.

The above descriptions are detail embodiments for carrying out the present disclosure. Embodiments in which a design is changed simply or which are easily changed may be included in the present disclosure as well as an embodiment described above. In addition, technologies that are easily changed and implemented by using the above embodiments may be included in the present disclosure. Therefore, the scope of the present disclosure should not be limited to the above-described embodiments and should be defined by not only the claims to be described later, but also those equivalent to the claims of the present disclosure.

What is claimed is:

1. A method of retrieving a digital twin model of a digital twin device that generates and manages digital twin models and binary tags representing features of each of the digital twin models, the method comprising:
generating a retrieval binary tag that matches a retrieval condition;
performing a logical operation between the retrieval binary tag and the binary tag representing the features of the digital twin model; and
adding model IDs of each of the digital twin models corresponding to the binary tag in a retrieval list when it is determined that the retrieval binary tag is the same as the binary tag, based on a result of the logical operation,
wherein each of the binary tags includes a plurality of bits to which a plurality of tags are respectively assigned, and
wherein each of the plurality of bits has a first logical value or a second logical value based on whether the digital twin models have features assigned to the corresponding tags.

2. The method of claim 1, further comprising:
when the binary tag is not a last binary tag, loading a subsequent binary tag.

3. The method of claim 1, wherein the logical operation is an AND operation between each bit of the retrieval binary tag and each bit of the corresponding binary tag.

4. The method of claim 1, wherein the logical operation is an XNOR (exclusive NOR) operation between each bit of the retrieval binary tag and each bit of the corresponding binary tag.

5. The method of claim 1, wherein the digital twin device includes:
a processing block configured to generate the digital twin models; and
a database block configured to store the digital twin models and the binary tags corresponding to each of the digital twin models,
wherein the binary tags are generated by the processing block.

6. The method of claim 5, wherein a mapping relationship between the digital twin models and the binary tags is stored in the database block.

7. The method of claim 5, wherein a mapping relationship between the digital twin models and the binary tags is stored in a buffer block included in the digital twin device, and
wherein the buffer block is configured to store data required for an operation of the digital twin device.

8. The method of claim 6, wherein the mapping relationship is stored in a mapping table, and
wherein the mapping table includes model IDs of each of the digital twin models and the binary tags.

9. A digital twin device configured to generate and manage digital twin models, comprising:
a processing block configured to generate the digital twin models; and
a database block configured to store the digital twin models and binary tags corresponding to each of the digital twin models,
wherein each of the binary tags includes a plurality of bits to which a plurality of tags are respectively assigned, and
wherein each of the plurality of bits has a first logical value or a second logical value based on whether the digital twin models have features assigned to the corresponding tags.

10. The digital twin device of claim 9, wherein the database block further includes a mapping module, and
wherein the mapping module includes a mapping relationship between the binary tags and the digital twin models.

11. The digital twin device of claim 9, wherein the processing block includes:
a digital twin generation module configured to generate the digital twin models;
a binary tag number generation module configured to generate the binary tags corresponding to the features of the digital twin models; and
a retrieval module configured to retrieve the binary tags.

12. The digital twin device of claim 9, wherein the database block includes:
a digital twin model data module configured to store the digital twin models; and
a binary tag number module configured to store the binary tags.

13. The digital twin device of claim 10, further comprising:
a buffer block configured to store data required for an operation of the processing block.

14. The digital twin device of claim 13, wherein the mapping relationship is stored in the buffer block.

15. The digital twin device of claim 13, wherein the database block further includes a mapping data module configured to store the mapping relationship.

16. The digital twin device of claim 13, wherein the mapping relationship is stored in the database block in a form of a mapping table between model IDs of each of the digital twin models and the binary tags.

17. A method of generating a digital twin model and a binary tag of a digital twin device configured to generate the digital twin models, the method comprising:
selecting a plurality of tags corresponding to each of the plurality of bits in the binary tag including a plurality of bits, and assigning a feature to each of the plurality of tags;
generating the digital twin model and changing values of the plurality of bits of the binary tag so as to match the feature of the digital twin model; and
storing the digital twin model and the binary tag,
wherein each of the plurality of bits has a first logical value or a second logical value based on whether the digital twin models have features assigned to the corresponding tags.
